(19) United States
(12) Patent Application Publication
(10) Pub. No.: US 2026/0024149 A1
(43) Pub. Date: Jan. 22, 2026

(54) RENEWABLE ENERGY WHEELING DISTRIBUTION SYSTEM AND METHOD

(71) Applicant: DELTA ELECTRONICS, INC., Taoyuan City (TW)

(72) Inventors: Ming Jia HUANG, Taoyuan City (TW); Guan De LI, Taoyuan City (TW); Hung Hsuan LIN, Taoyuan City (TW); Jea Hong CHOU, Taoyuan City (TW); Chen Ting LIEN, Taoyuan City (TW)

(21) Appl. No.: 19/211,276

(22) Filed: May 18, 2025

(30) Foreign Application Priority Data
Jul. 19, 2024 (CN) 202410973564.7

(51) Int. Cl. G06Q 50/06; G06Q 40/04; H02J 3/00

(52) U.S. Cl. CPC G06Q 50/06; G06Q 40/04; H02J 3/00; H02J 2203/20

(57) ABSTRACT

Renewable energy wheeling distribution systems and methods include providing a model for performing green electricity optimization on at least one electricity consumption site based on a genetic algorithm and gradient descent to generate, based on an objective according to electricity generation parameters and at least one electricity consumption parameter, at least one wheeling solution including matching relationships of green electricity between the at least one electricity consumption site and electricity generation sites, as well as the proportion for allocating the green electricity within the matching relationships; repeatedly performing the green electricity optimization on a specific electricity consumption site based on renewable energy objectives to generate wheeling solutions; and calculating, based on the plurality of wheeling solutions and cost parameters, a renewable energy marginal cost as a ratio of a variation of electricity purchase expenses to an increment of green electricity corresponding to adjacent two of the objectives.

### CROSS REFERENCE TO RELATED APPLICATIONS

This application claims the benefit of and priority to China Patent Applications No. 202410973564.7, titled “RENEWABLE ENERGY WHEELING DISTRIBUTION SYSTEM AND METHOD,” filed Jul. 19, 2024, the entirety of which is hereby incorporated herein by reference.

### FIELD OF THE INVENTION

The present disclosure relates to an energy distribution technology, and in particular to renewable energy wheeling distribution systems and methods.

### BACKGROUND OF THE INVENTION

Based on the global carbon reduction trend, renewable energy has become an important demand for enterprises. However, if renewable energy is not carefully planned for energy distribution between supply and demand sites, then it is easy to waste renewable energy and costs due to seasonal and period characteristics. Although there have been some energy distribution technologies in the past, they still need to be improved.

### SUMMARY OF THE INVENTION

An object of the present disclosure is to provide renewable energy wheeling distribution systems and methods that effectively meet the needs of renewable energy distribution.

To achieve the above object, one aspect of the present disclosure is to provide a renewable energy wheeling distribution system including a processor and a memory, wherein the processor is coupled to the memory storing instructions and configured to execute the instructions to perform processes including: providing a model for performing green electricity optimization on at least one electricity consumption site based on a genetic algorithm and a gradient descent algorithm, wherein the model generates at least one wheeling solution that satisfies a renewable energy objective according to a plurality of electricity generation parameters and at least one electricity consumption parameter, wherein the at least one wheeling solution includes matching relationships of green electricity between the at least one electricity consumption site and a plurality of electricity generation sites, as well as the proportion for allocating the green electricity within the matching relationships; repeatedly performing the green electricity optimization on a specific electricity consumption site based on a plurality of renewable energy objectives to generate a plurality of wheeling solutions; and calculating, based on the plurality of wheeling solutions and cost parameters, a renewable energy marginal cost as a ratio of a variation of electricity purchase expenses to an increment of green electricity corresponding to adjacent two of the renewable energy objectives.

To achieve the above object, another aspect of the present disclosure is to provide a renewable energy wheeling distribution method applied to a system including a processor and a memory, wherein the processor is coupled to the memory storing instructions which, when executed by the processor, cause the processor to execute the method including: providing a model for performing green electricity optimization on at least one electricity consumption site based on a genetic algorithm and a gradient descent algorithm, wherein the model generates at least one wheeling solution that satisfies a renewable energy objective according to a plurality of electricity generation parameters and at least one electricity consumption parameter, wherein the at least one wheeling solution includes matching relationships of green electricity between the at least one electricity consumption site and a plurality of electricity generation sites, as well as the proportion for allocating the green electricity within the matching relationships; repeatedly performing the green electricity optimization on a specific electricity consumption site based on a plurality of renewable energy objectives to generate a plurality of wheeling solutions; and calculating, based on the plurality of wheeling solutions and cost parameters, a renewable energy marginal cost as a ratio of a variation of electricity purchase expenses to an increment of green electricity corresponding to adjacent two of the renewable energy objectives.

To achieve the above object, another aspect of the present disclosure is to provide a renewable energy wheeling distribution system including a processor and a memory, wherein the processor is coupled to the memory storing instructions and configured to execute the instructions to perform processes including: generating at least one wheeling solution based on a renewable energy objective according to a plurality of electricity generation parameters and at least one electricity consumption parameter, wherein the at least one wheeling solution includes matching relationships of green electricity between the at least one electricity consumption site and a plurality of electricity generation sites, as well as the proportion for allocating the green electricity within the matching relationships; and repeatedly performing an operation of green electricity optimization on a specific electricity consumption site based on a plurality of renewable energy objectives to generate a plurality of wheeling solutions; and calculating, based on the plurality of wheeling solutions and cost parameters, a renewable energy marginal cost as a ratio of a variation of electricity purchase expenses to an increment of green electricity corresponding to adjacent two of the renewable energy objectives.

To achieve the above object, another aspect of the present disclosure is to provide a renewable energy wheeling distribution system including a processor and a memory, wherein the processor is coupled to the memory storing instructions and configured to execute the instructions to perform processes including: generating at least one wheeling solution based on a renewable energy objective according to a plurality of electricity generation parameters and at least one electricity consumption parameter, wherein the at least one wheeling solution includes matching relationships of green electricity between the at least one electricity consumption site and a plurality of electricity generation sites, as well as the proportion for allocating the green electricity within the matching relationships; and repeatedly performing green electricity optimization on a specific electricity consumption site based on a plurality of renewable energy objectives to generate a plurality of wheeling solutions, to generate a plurality of costs per electricity purchase corresponding to each renewable energy objective according to a plurality of electricity purchase expenses corresponding to the plurality of renewable energy objectives, and to generate an electricity purchase guide according to the plurality of costs per electricity purchase and a cost of purchasing renewable-energy certificates, wherein the electricity purchase guide indicates a recommendation to either purchase renewable energy from the at least one electricity consumption site, or purchase the renewable-energy certificates.

Renewable energy wheeling distribution systems and methods are provided. For example, a model is provided to perform an operation of green electricity optimization on at least one electricity consumption site based on a genetic algorithm and a gradient descent algorithm to generate at least one wheeling solution based on a renewable energy objective according to a plurality of electricity generation parameters and at least one electricity consumption parameter, wherein the at least one wheeling solution includes matching relationships of green electricity between the at least one electricity consumption site and a plurality of electricity generation sites, as well as the proportion for allocating the green electricity within the matching relationships; green electricity optimization is repeatedly performed on a specific electricity consumption site based on a plurality of renewable energy objectives to generate a plurality of wheeling solutions; a renewable energy marginal cost as a ratio of a variation of electricity purchase expenses to an increment of green electricity corresponding to adjacent two of the renewable energy objectives is calculated based on the plurality of wheeling solutions and cost parameters; alternatively, an electricity purchase guide is generated according to a plurality of costs per electricity purchase corresponding to the plurality of renewable energy objectives, a plurality of costs per electricity purchase, and a cost of purchasing renewable-energy certificates. In this way, it is conducive to accurately achieving a wheeling objective, efficiently controlling costs, and considering alternative solutions for cost needs, such as purchasing energy certificates.

### BRIEF DESCRIPTION OF THE DRAWINGS

FIG. 1 is a schematic diagram illustrating a renewable energy supply and demand scenario applied in an embodiment of the present disclosure.

FIG. 2 is a schematic diagram illustrating a functional configuration of the renewable energy wheeling distribution system applied in an embodiment of the present disclosure.

FIG. 3 is a schematic diagram illustrating an application scenario of an optimization process applied in an embodiment of the present disclosure.

FIGS. 4 to 9 are schematic diagrams illustrating a multi-stage calculation process for optimization applied in FIG. 3.

FIG. 10 is a schematic diagram illustrating visualization of a wheeling result applied in an embodiment of the present disclosure.

FIG. 11 is a schematic diagram of an application scenario for an optimization algorithm applied in an embodiment of the present disclosure.

FIG. 12 is a flowchart illustrating a process of executing an optimization algorithm applied in an embodiment of the present disclosure.

FIGS. 13 to 16 are schematic diagrams of multi-stage execution scenarios of a double-layered algorithm shown in FIG. 12.

FIGS. 17A and 17B are schematic diagrams illustrating bidirectional RE-cost trend-sweeping results applied in an embodiment of the present disclosure.

FIG. 18 is a schematic diagram illustrating renewable-energy cost analysis applied in an embodiment of the present disclosure.

FIG. 19 is a schematic diagram illustrating unit price analysis for renewable energy applied in an embodiment of the present disclosure.

### THE DETAILED DESCRIPTION OF PREFERRED EMBODIMENTS

To make the above and other objects, features, and advantages of the present disclosure more apparent and understandable, preferred embodiments of the present disclosure will be described in detail below along with the accompanying drawings.

Based on the global trend of carbon reduction, using renewable energy has become an important demand for enterprises. For example, the Global Renewable Energy Initiative brings together the world's most influential companies to improve the friendly environment for using green electricity from the perspective of electricity demand. An example is provided in Taiwan. The current practice is to manually set a wheeling contract based on wheeling computation rules proposed by Taiwan Power Corporation. Wheeling refers to distributing green electricity (renewable energy) from an electricity generation site to an electricity consumption site. However, this method cannot achieve the renewable energy objective accurately and can only be adjusted manually, and the cost is not easy to control. Furthermore, this method only provides solutions for wheeling green electricity in a green-electricity-friendly usage environment, and alternative solutions that meet cost needs, such as purchasing energy certificates, have not yet been considered. Given the above, the present disclosure proposes a renewable energy wheeling scheme. Examples are given below but are not limited to the description here.

In an aspect, an embodiment of the present disclosure provides a renewable energy wheeling distribution system including a processor and a memory, wherein the processor is coupled to the memory storing instructions and configured to execute the instructions to perform processes including: providing a model for performing green electricity optimization on at least one electricity consumption site based on a genetic algorithm and a gradient descent algorithm, wherein the model generates at least one wheeling solution that satisfies a renewable energy objective according to a plurality of electricity generation parameters and at least one electricity consumption parameter, wherein the at least one wheeling solution includes matching relationships of green electricity between the at least one electricity consumption site and a plurality of electricity generation sites, as well as the proportion for allocating the green electricity within the matching relationships; repeatedly performing the green electricity optimization on a specific electricity consumption site based on a plurality of renewable energy objectives to generate a plurality of wheeling solutions; and calculating, based on the plurality of wheeling solutions and cost parameters, a renewable energy marginal cost as a ratio of a variation of electricity purchase expenses to an increment of green electricity corresponding to adjacent two of the renewable energy objectives. But it is not limited to the description here. In other embodiments, the processor of the renewable energy wheeling distribution system can also be configured to execute instructions to perform the processes such as a part of characteristics of embodiments as described above or as described below. For example, besides providing the model, characteristics other than the green electricity optimization on at least one electricity consumption site are performed based on the genetic algorithm and the gradient descent algorithm.

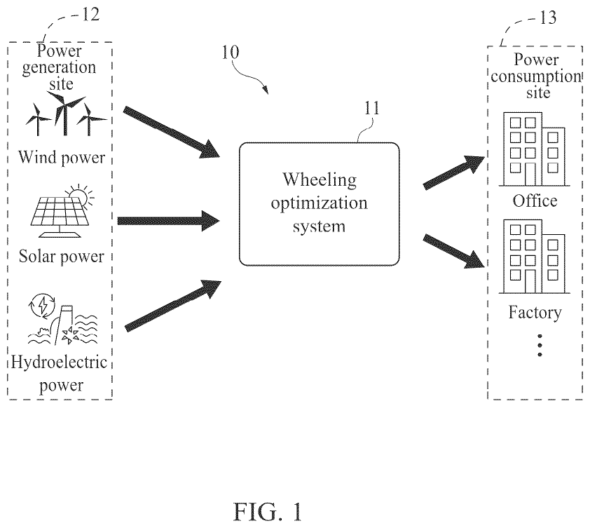

For example, as shown in FIG. 1, a renewable energy supply and demand scenario example 10 includes a wheeling optimization system 11 for generating at least one wheeling solution, such as generating a wheeling contract, so as to wheel green electricity from several electricity generation sites (e.g., power stations for renewable energy such as wind, solar, hydropower, geothermal, and tidal) 12 to at least one electricity consumption site (such as an office or factory) 13.

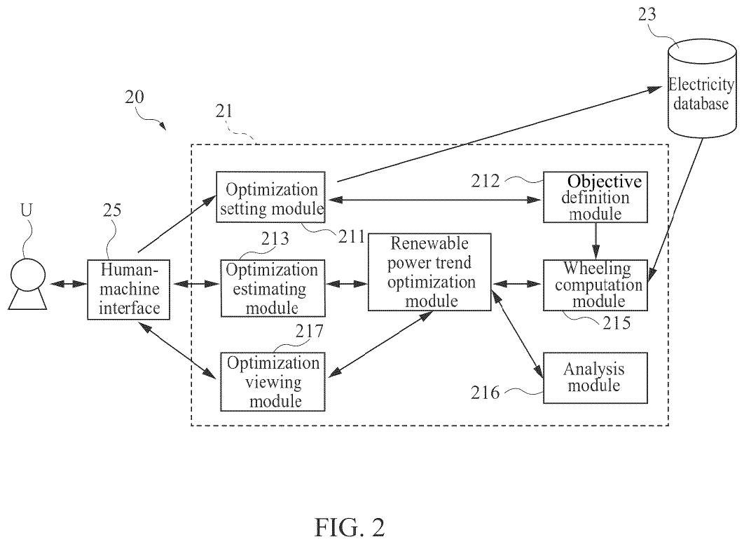

As shown in FIG. 2, a functional configuration example 20 includes a system 21, such as a renewable energy wheeling distribution system. The system 21 can receive data from an electricity database 23 and receive instructions and objective data through a human-machine interface 25 to generate at least one wheeling solution. The wheeling solution can be presented on the human-machine interface 25 so that the user U can obtain the wheeling solution.

As shown in FIG. 2, the system 21 can be a computer or a cloud computing platform, the electricity database 23 can be a database owned by a power company, and the human-machine interface 25 can be a device with a display, such as a touch screen, a smartphone, a tablet, or a notebook. For example, the system 21 includes at least one processor and at least one memory. The processor is electrically connected to the memory. The memory stores at least one instruction. When the processor executes the instruction, the instruction causes the processor to generate a plurality of software modules to execute a renewable energy wheeling distribution method to determine how to distribute power between the electricity generation sites and the electricity consumption site. For example, power distribution is associated with wheeling contracts and calculation rules specified in a power company's renewable energy operation regulations. After completing the power distribution process, the electricity each electricity consumption site can obtain from the electricity generation sites (for example, through the wheeling contracts) can be known. In other embodiments, at least one part of the software modules mentioned above may also be configured as hardware modules, such as application-specific integrated circuits (ASICs).

Additionally, embodiments of the present disclosure can also count other indicators. For example, RE values of the electricity consumption site (such as RE1, RE2, RE3, . . . , RE99, and RE100) represent the ratio (%) of wheeled green electricity to total electricity consumption. The surplus electricity at the electricity generation site is a difference obtained by subtracting the wheeled green electricity from the generated electricity. A surplus-electricity purchase expense (Top) is the expense users pay for the surplus electricity (the price per kilowatt hour needs to be negotiated with the electricity generation company). The total cost is the sum of the product of gray electricity and a gray electricity rate, the product of wheeled green electricity and a green electricity rate, and the surplus-electricity purchase expense.

As shown in FIG. 2, the system 21 includes an optimization setting module 211, an objective definition module 212, an optimization estimating module 213, a renewable energy trend optimization module 214, a wheeling computation module 215, an analysis module 216, and an optimization viewing module 217. For example, the optimization setting module 211 can be used to set the parameters that can be optimized in a wheeling contract, such as the proportion of the electricity generation site in the wheeling contract, whether the wheeling contract is provided to the electricity consumption site, the number of wheeling contracts, the upper limit for wheeling, and so on. The optimization setting module 211 can also send a signal to the electricity database 23 to input data, such as electricity generation data and electricity consumption data obtained intermittently (such as every 15 minutes). The optimization setting module 211 can also send a signal to the electricity database 23 to output data, such as the electricity actually provided by the electricity generation sites to the electricity consumption site according to the contracts. The objective definition module 212 can define renewable energy objectives based on the data from the optimization setting module 211, such as a renewable ratio of the wheeled green electricity to the electricity consumption (such as RE1 to RE100), which can be output to the wheeling computation module 215 to calculate at least one wheeling result. The optimization estimating module 213 can perform an optimization estimating process based on the parameters input by a user U through the human-machine interface 25, such as optimizing the parameters that can be optimized in the wheeling contract to generate optimization results that are used to be the basis for converting into wheeling contracts. The renewable energy trend optimization module 214 can generate at least one renewable energy optimization trend based on an optimization result from the optimization estimation module 213 and a wheeling result from the wheeling computation module 215, such as an optimization trend from RE90 to RE100. The optimization trend includes several optimization solutions corresponding to the renewable energy proportion values, such as the electricity charges of several renewable energy proportions. The analysis module 216 can analyze several optimization solutions to analyze a trend. For example, forward-sweeping/reverse-sweeping is associated with the trend of the total electricity purchase expense being monotonically increasing/decreasing when a renewable ratio increases/decreases. An output result of the renewable energy trend optimization module 214 can also be adjusted by the optimized viewing module 217 to adjust a viewing mode to generate an optimized view (such as a waterfall chart) to be output to the human-machine interface 25.

The following example illustrates an optimization process and discusses how an electricity-consumption enterprise with stable electricity consumption should sign a wheeling contract to achieve RE90. Still, it is not limited to the description here.

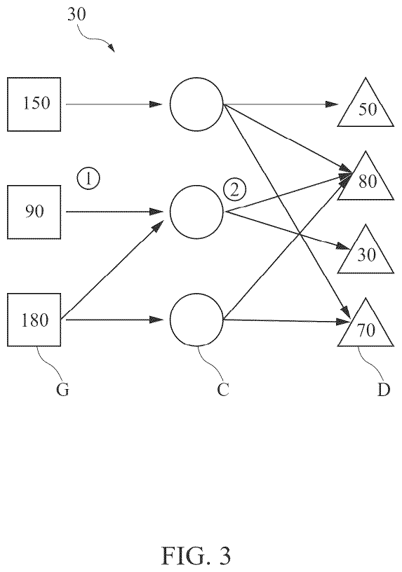

For example, as shown in FIG. 3, in an optimization process example 30, assuming that there are three electricity generation sites G, four electricity consumption sites D, and three contracts C. In terms of parameters that can be optimized in the wheeling contract, a mark “\textcircled{1}” between the electricity generation sites G and the contracts C represents a wheeling ratio (Pₘᵢ) of the m-th (such as m=1˜3) electricity generation site G for the i-th (such as i=1˜3) contract C; another mark “\textcircled{2}” between the electricity consumption sites D and the contracts C represents whether the n-th (such as n=1˜4) electricity consumption site D participates in the i-th (such as i=1˜3) contract C. In addition, there are two ends of each arrow in FIG. 3 indicates two members are relevant. Further, the exhaustive method can confirm the number of wheeling contracts. Because setting a wheeling upper limit to a sufficiently large value is practical, the wheeling upper limit can be assumed to be infinite.

It should be understood that the wheeling computation rules can refer to the specifications defined by an electric power company herein. The 13th part of the operating regulation provided by the Taiwan Power Company is merely taken as an example, but it is not limited to the description here. Other electricity wheeling computation rules may also be applied. In addition, the wheeling computation, for example, includes two stages: the first stage is to wheel electricity every 15 minutes (taken as an example), wherein the electricity shortfall amount and the surplus electricity can be calculated after a wheeling process is completed; the second stage is to distribute based on the results of electricity wheeled every 15 minutes within the same month. For example, the power company calendar classifies them into four periods: “peak,” “half-peak,” “off-peak,” and “after half-peak on Saturday,” and then the distribution during the same period is performed according to the wheelable electricity. In addition, the input data required for the wheeling computation includes the electricity generation data of each electricity generation site, the electricity consumption data of each electricity consumption site per 15 minutes, and the wheeling contract. Further, after the wheeling computation, the output data includes the electricity from the electricity generation site to the electricity consumption site through the wheeling contract. Examples are given below but are not limited to the description here.

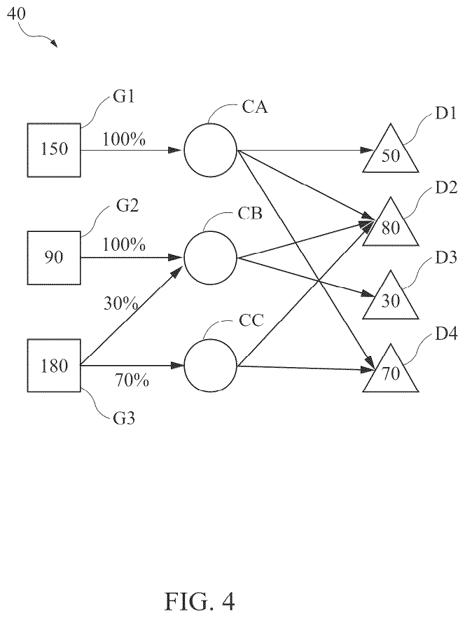

As shown in FIG. 4, a calculation process example 40 is provided, in which the wheeling upper limit is not considered; values are rounded to the first decimal place. Assuming that the current period is the peak period, there are three electricity generation sites G1, G2, and G3, and the electricity generation is 150, 90, and 180 units of electricity (e.g., kilowatt hours), respectively; there are four electricity consumption sites D1, D2, D3, and D4, and the electricity consumption is 50, 80, 30, and 70 units of electricity (e.g., kilowatt hours), respectively; there are three contracts (such as wheeling contracts) CA, CB, and CC. The contract CA indicates that a green electricity ratio taken from the electricity generation site G1 is 100% distributed to the electricity consumption sites D1, D2, and D4. The contract CB indicates that green electricity ratios taken from the electricity generation sites G2 and G3 are 100% and 30% distributed to the electricity consumption sites D2 and D3, respectively. The contract CC indicates that a green electricity ratio taken from the electricity generation site G3 is 70% distributed to the electricity consumption sites D2 and D4. An example of the 15-minute wheeling computation process is provided as follows.

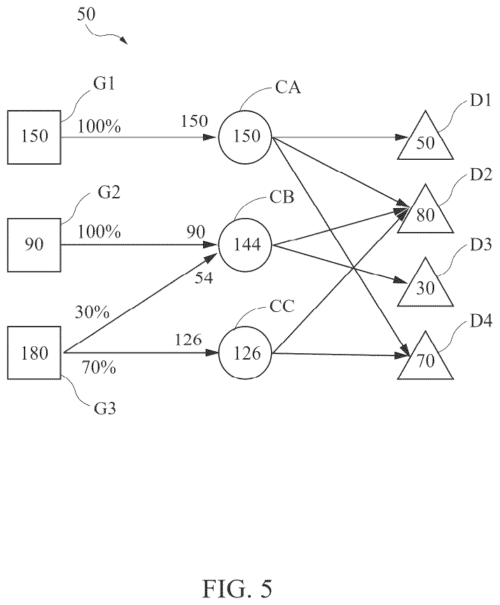

The first process, as shown in FIG. 5, in a calculation process example 50, includes: calculating the available electricity from each electricity generation site eligible for wheeling under each contract, that is, the sum of the products of the electricity generation and the proportion of each electricity generation site that a single wheeling contract can obtain. For example, the contract CA can obtain 150 (=150*100%) units of electricity from the electricity generation site G1, i.e., the contract CA can wheel 150 units of electricity; the contract CB can obtain 90(=90*100%) units of electricity from the electricity generation site G2 and 54 (=180 *30%) units of electricity from the electricity generation site G3, i.e., the contract CB can wheel 144 (=90+54) units of electricity; the contract CC can obtain 126 (=180*70%) units of electricity from the electricity generation site G3, i.e., the contract CC can wheel 126 units of electricity.

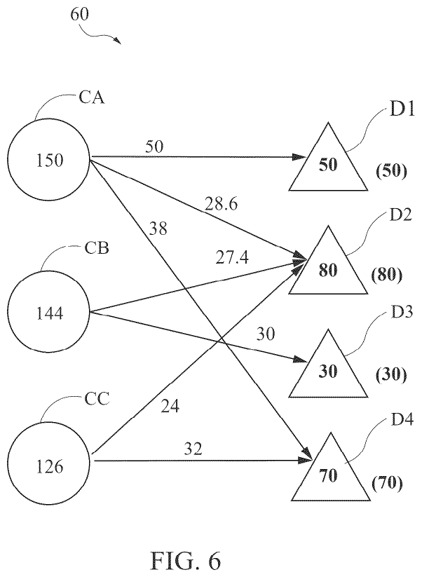

The second process, as shown in FIG. 6, in a calculation process example 60, includes: calculating the amount of electricity that can be wheeled to the electricity consumption site under the wheeling contract, that is, the product of the electricity that can be wheeled under a single wheeling contract and a ratio of electricity consumption of each electricity consumption site to the total electricity consumption of all electricity consumption sites under the wheeling contract. For example, the contract CA can wheel 50 (=50*150/(150)) units of electricity to the electricity consumption site D1; the contract CA can wheel 28.6 (=80*150/(150+144+126)) units of electricity to the electricity consumption site D2; the contract CA can wheel 38 (=70*150/(150+126)) units of electricity to the electricity consumption site D4; the contract CB can wheel 27.4 (=80*144/(150+144+126)) units of electricity to the electricity consumption site D2; the contract CB can wheel 30 (=30*144/(144)) units of electricity to the electricity consumption site D3; the contract CC can wheel 24 (=80*126/(150+144+126)) units of electricity to the electricity consumption site D2; the contract CC can wheel 32 (=70*126/(150+126) units of electricity to the electricity consumption site D4. In addition, the total electricity that can be wheeled to each electricity consumption site is calculated by summing up the electricity from each wheeling contract to a single electricity consumption site. For example, the electricity consumption site D1 has a total of 50 units of electricity from the contract CA, the electricity consumption site D2 has a total of 80 (=28.6+27.4+24) units of electricity from the contracts CA, CB, and CC, the electricity consumption site D3 has a total of 30 units of electricity from the contract CB, and the electricity consumption site D4 has a total of 70 (=38+32) units of electricity from contract CA and CC.

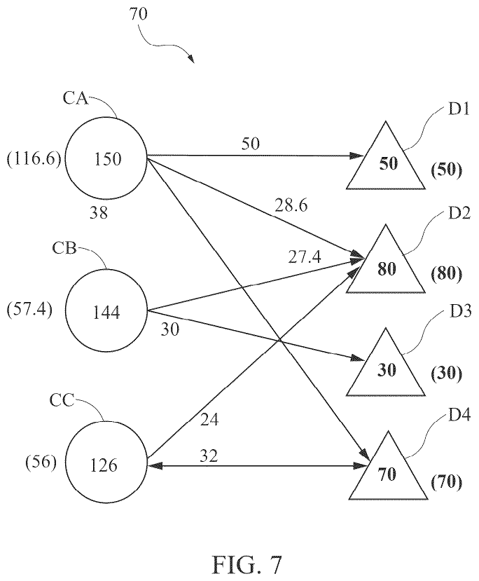

The third process, as shown in FIG. 7, in a calculation process example 70, includes: calculating the electricity that can be matched between the contracts and the electricity consumption site. If the contract's wheeling capacity meets (greater than or equal to) electricity awaiting wheeling of the contract, no adjustment is required. If the electricity awaiting wheeling of the contract exceeds the wheeling capacity of the contract, the electricity awaiting wheeling needs to be adjusted according to the proportion of electricity consumption. For example, the wheeling capacity of the contract CA is 116.6 (=50+28.6+38) units of electricity, the wheeling capacity of the contract CB is 57.4 (=27.4+30) units of electricity, and the wheeling capacity of the contract CC is 56 (=24+32) units of electricity. Then, it can be determined whether the electricity awaiting wheeling must be adjusted. For example, the wheeling capacity of the contract CA is 150 units of electricity, and the electricity awaiting wheeling of the contract CA is 111.6 units of electricity (i.e., no adjustment is needed because 116.6 is less than 150); the wheeling capacity of the contract CB is 144 units of electricity and the electricity awaiting wheeling of the contract CB is 57.4 units of electricity (i.e., no adjustment is needed because 57.4 is less than 144); the wheeling capacity of the contract CC is 126 units of electricity, and the electricity awaiting wheeling of the contract CC is 56 units of electricity (i.e., no adjustment is needed because 56 is less than 126). In this example, contracts CA, CB, and CC do not need to adjust the electricity. However, because of the need to explain, the following example illustrates the adjustment case of the electricity awaiting wheeling and adjustment methods. For example, assuming that the wheeling capacity of the contract CC is 50 units of electricity (less than the electricity awaiting wheeling, which is 56 units of electricity), the electricity awaiting wheeling needs to be adjusted to match the wheeling capacity. In addition, assuming that the electricity awaiting wheeling from the contract CC to the electricity consumption site D2 is adjusted from 24 to 21.4 (=50*24/(24+32)) units of electricity, and the electricity awaiting wheeling from the contract CC to the electricity consumption site D4 is adjusted from 32 to 28.6 (=50*32/(24+32)) units of electricity so that the total electricity awaiting wheeling of the contract CC is 50.

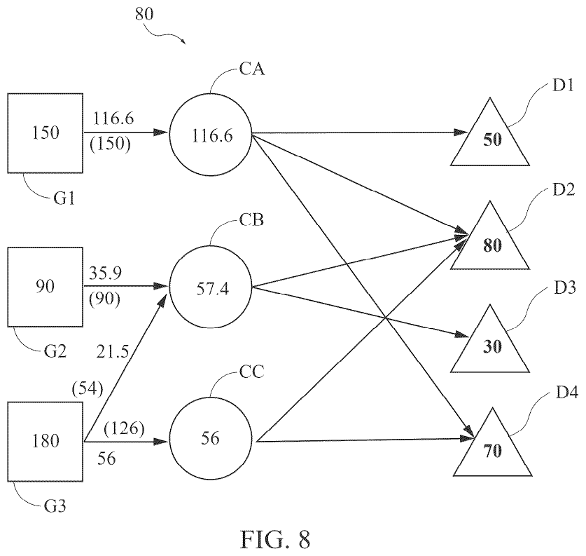

The fourth process, as shown in FIG. 8, in a calculation process example 80, includes: calculating the actual wheeling electricity between the electricity generation site and the contract, that is, deducing the actual electricity wheeled from each electricity generation site according to the ratio of the electricity generation site to each contract. For example, the actual wheeling electricity from the electricity generation site G1 is 116.6 units of electricity, which includes the electricity awaiting wheeling to the contract CA is 116.6 units of electricity; the actual wheeling electricity from the electricity generation site G2 is 35.9 units of electricity, which includes the electricity awaiting wheeling to the contract CB is 35.9 (=57.4*90/(90+180)) units of electricity; the actual wheeling electricity from the electricity generation site G3 is 77.5 units of electricity, which includes the electricity awaiting wheeling to the contract CB being 21.5 (=57.4*180/(90+180)) units of electricity and the electricity awaiting wheeling to the contract CC being 56 units of electricity. Therefore, the wheeling electricity from the electricity generation site G1 is 116.6 units of electricity (less than the electricity generation of 150 units of electricity), the electricity awaiting wheeling from the electricity generation site G2 is 35.9 units of electricity (less than the electricity generation of 90 units of electricity), and the electricity awaiting wheeling from the electricity generation site G3 is 77.5 units of electricity (less than the electricity generation of 180 units of electricity).

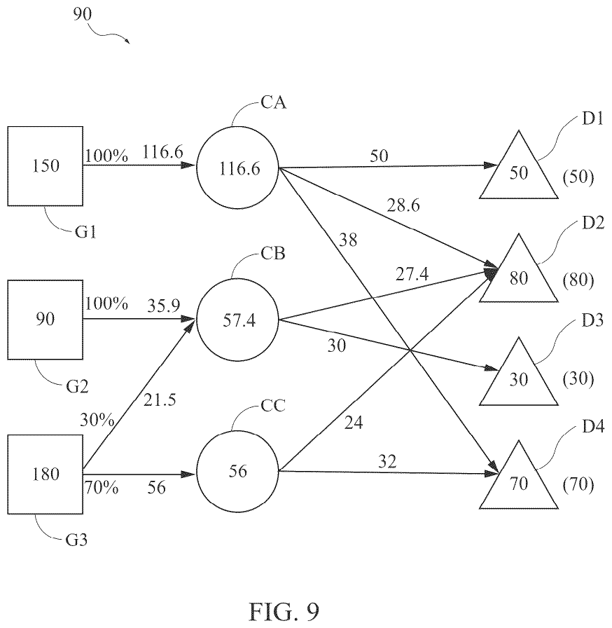

The fifth process, as shown in FIG. 9, in a calculation process example 90, includes: performing statistics of relevant indicators, such as renewable ratios and costs, after calculating the wheeling electricity. These indicators are the most significant concern to the electricity consumption site (such as enterprises). The result is also the final indicator of concern in the optimization process. For example, the total electricity generation of the electricity generation sites G1, G2, and G3 is 420 (=150+90+180) units of electricity, and the total electricity consumption of the electricity consumption sites D1, D2, D3, and D4 is 230 (=50+80+30+70) units of electricity, the total wheeling electricity of the contracts CA, CB, and CC is 230 (=116.6+57.4+56) units of electricity, the renewable ratio RE % is 100 (=230/230), the surplus electricity is 190 (=420−230) units of electricity, and the gray electricity is 0 (=230−230) units of electricity.

In the present disclosure, since the wheeling computation process involves calculating the wheeling information of each electricity generation site (or electricity consumption site), the aforementioned statistics can also be applied to a single electricity generation site (or electricity consumption site). In addition, if the price per electricity unit of renewable energy at each electricity generation site can be known, the renewable energy expense can further be calculated by multiplying the actual wheeling electricity of each electricity generation site by the price per electricity unit to obtain the renewable energy expense. In addition, the gray electricity expense can refer to the power company's pricing policy to query the service fee rate for the corresponding 15-minute period and then multiply it by the corresponding electricity price to obtain the gray electricity expense. In this example, the period is the peak period and assuming that the service fee rate during the peak period is 7 TWD per kilowatt hour, the gray electricity expense is 0 TWD (=0*7).

In some embodiments, the system can perform processes including: performing green electricity optimization on a plurality of electricity consumption sites based on a specific renewable energy objective in response to a request; and generating a display interface based on the matching relationships of green electricity between the plurality of electricity consumption sites and the plurality of electricity generation sites within the wheeling solution, wherein the display interface includes a plurality of first visual characteristics corresponding to the plurality of electricity generation sites, a plurality of second visual characteristics corresponding to the plurality of electricity consumption sites, and a plurality of intermediate visual characteristics corresponding to the matching relationships and located between the plurality of first visual characteristics and the plurality of second visual characteristics, and wherein the display interface further includes flows, in which each of the plurality of first visual characteristics is connected to at least one of the plurality of second visual characteristics through at least one of the plurality of intermediate visual characteristics.

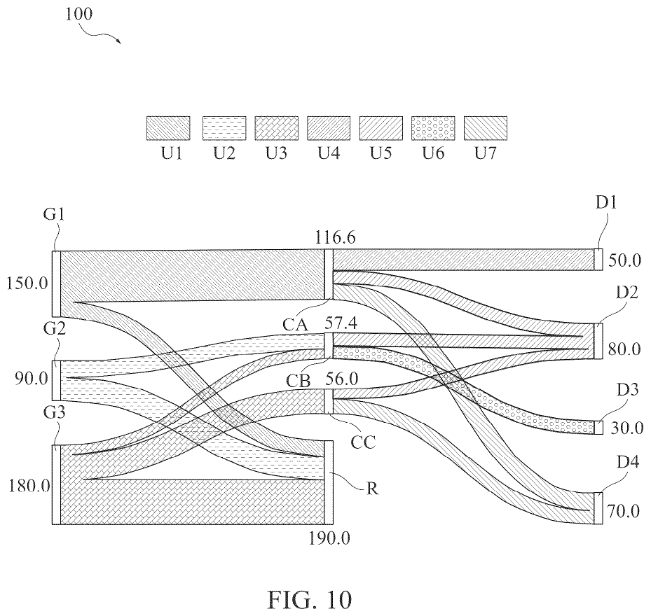

For example, the relationship between the electricity generation sites and the electricity consumption site and the contract between them in the above example can be further visualized. The following provides a visualization case with surplus electricity but is not limited to the description here. For example, the case does not need to show the surplus electricity, or the visual case can also show the gray electricity, and the visual content can be adjusted for requirements according to the actual application. For example, the Sankey Chart presents wheeling results, as shown in FIG. 10, in a wheeling visualization example 100, the left side is the electricity generation sites G1, G2, and G3 (e.g., electricity generation is 150, 90, and 180 units of electricity, respectively), and the right side is the electricity consumption sites D1, D2, D3, and D4 (i.e., the electricity consumption is 50, 80, 30, and 70, respectively). The middle part includes contracts CA, CB, and CC (e.g., wheelable electricity is 116.6, 57.4, and 56.0 units of electricity, respectively), and the surplus electricity R is 190. It can be seen in the present figure that the power between the electricity generation site and the electricity consumption site is wheeled through which one or more contracts (acting as intermediaries, bridges, or distributors) perform wheeling. Flows of the wheeling and surplus electricity can be represented by different visual characteristics (such as colors, textures, or patterns). The electricity provided by each electricity generation site is distributed to which contract(s) (such as intermediary symbols), and the wheeling capacity of each contract is distributed to which electricity consumption site(s). For example, a first flow characteristic (e.g., the first pattern) U1 represents the electricity from the electricity generation site G1 distributed to the contract CA and the surplus electricity R. A second flow characteristic (e.g., the second pattern) U2 represents the electricity from the electricity generation site G2 distributed to the contract CB and the surplus electricity R. A third flow characteristic (e.g., the third pattern) U3 represents the electricity from the electricity generation site G3 distributed to the contract CB, the contract CC, and the surplus electricity R. A fourth flow characteristic (such as the fourth pattern) U4 represents the electricity distributed from the contract CA to the electricity consumption site D1. A fifth flow characteristic (such as the fifth pattern) U5 represents the electricity distributed from the contract CA, the contract CB, and the contract CC to the electricity consumption site end D2. A sixth flow characteristic (such as the sixth pattern) U6 represents the electricity distributed from the contract CB to the electricity consumption site D3. A seventh flow characteristic (such as the seventh pattern) U7 represents the electricity distributed from the contract CA and the contract CC to the electricity consumption site D4. Still, they are not limited to the description here. As shown in FIG. 10, the first flow characteristic U1, the second flow characteristic U2, the third flow characteristic U3, the fourth flow characteristic U4, the fifth flow characteristic U5, the sixth flow characteristic U6, and the seventh flow characteristic U7 can also be different colors, such as red, orange, yellow, green, blue, indigo, purple, and other colors. Specifically, both sides of the contract CA are respectively connected to (the first flow pattern U1) and (the fourth flow pattern U4, the fifth flow pattern U5, and the seventh flow pattern U7), indicating that the partial electricity from the electricity generation site G1 is wheeled to the electricity consumption sites D1, D2, and D4 through the contract CA. Both sides of the contract CB are respectively connected to (the second flow pattern U2 and the third flow pattern U3) and (the fifth flow pattern U5 and the sixth flow pattern U6), representing that the partial electricity of the electricity generation site G2 and the partial electricity from the electricity generation site G3 are wheeled to the electricity consumption sites D2 and D3 through the contract CB. Both sides of the contract CC are respectively connected to (the third flow pattern U3) and (the fifth flow pattern U5 and the seventh flow pattern U7), indicating the partial electricity from the electricity generation site G3 is wheeled to the electricity consumption sites D2 and D4 through the contract CC. Specifically, each electricity generation site, each contract, the surplus electricity, and each electricity consumption site can also be represented by different visual characteristics (such as colors, textures, or patterns).

In some embodiments, the display interface further includes a surplus-electricity visual characteristic located between the plurality of first visual characteristics and the plurality of second visual characteristics, and the display interface further includes one or more flows in which at least one of the plurality of first visual characteristics is connected to the surplus-electricity visual characteristic. In addition, the system can further perform a process of forming data for a waterfall chart according to the flows, setting the data for the waterfall chart corresponding to one or more flows of each of the plurality of first visual characteristics to be associated with a color, and setting the data for the waterfall chart corresponding to one or more flows of each of the plurality of second visual characteristics to be associated with a color, wherein the color associated with each of the plurality of first visual characteristics and the color associated with each of the plurality of second visual characteristics are different. Furthermore, the system can further perform a process of setting the plurality of first visual characteristics, the plurality of second visual characteristics, and the plurality of intermediate visual characteristics to be associated with a plurality of colors. In this way, a WYSIWYG (what you see is what you get) visual wheeling distribution result can be provided, allowing users to clearly understand the matching relationship between the electricity generation sites, the electricity consumption sites, and the contracts between them.

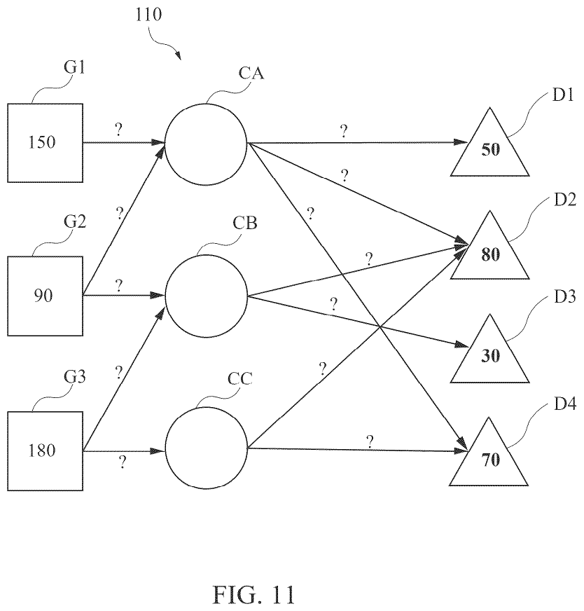

In addition, as shown in FIG. 11, an application scenario example 110 of an optimization algorithm is shown. According to the user's objectives, the wheeling contract parameters in a wheeling scenario are optimized. It is assumed that neither the wheeling upper limit nor the number of wheeling contracts is considered. The wheeling parameters that can be optimized include: electricity ratios between the wheeling contracts CA, CB, CC and the electricity generation sites G1, G2, and G3 (the ratio is 0, regarded as there is no connection) is called as Pₘᵢ, e.g., a real number such as a ratio or a decimal, in the algorithm. Whether there is a connection between the wheeling contract CA, CB, CC and the electricity consumption sites D1, D2, D3, and D4 is called as Lₙᵢ in the algorithm, its value can be an integer such as 1 (representing “yes”) or 0 (representing “no”). An example of an application scenario is described as follows. If an optimization problem is that the user sets RE100 as the renewable energy objective, how should the wheeling contracts CA, CB, and CC be set to achieve this renewable energy objective?

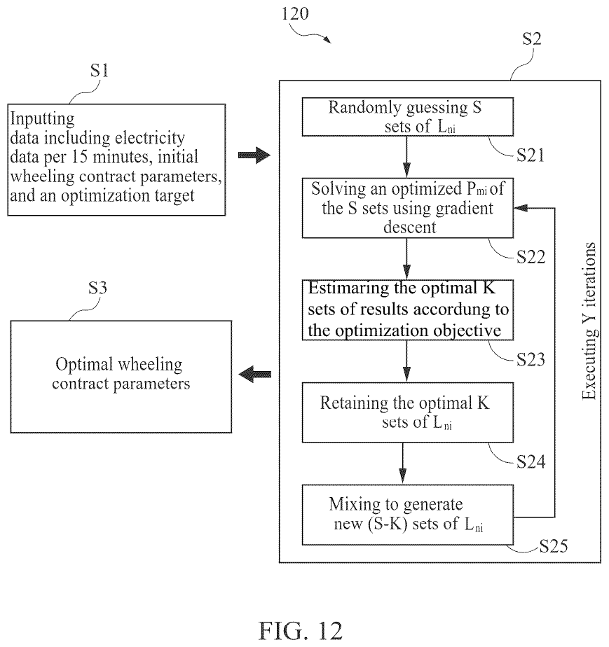

As shown in FIG. 12, an execution flow example 120 of an optimization algorithm includes steps S1 to S3. In step S1, data including electricity data per 15 minutes, initial wheeling contract parameters, and an optimization objective is input, and then proceed to step S2. In step S2, a double-layered algorithm is executed; for example, an outer-layered algorithm is a genetic algorithm, an inner-layered algorithm is a gradient descent algorithm, and step S2 includes steps S21 to S25. In step S21, the genetic algorithm is executed to randomly generate S sets of first parameters Lₙᵢ, wherein S is the number of populations, and then proceed to step S22. In step S22, a respective optimized second parameters Pₘᵢ of each of the S sets of first parameters Lₙᵢ is solved using the gradient descent algorithm, and then proceed to step S23. In step S23, the optimal K sets of first parameters Lₙᵢ is estimated according to the optimization objective, wherein K is the optimal number used to select the sets of first parameters close to the optimized second parameter in each generation, and then proceed to step S24. In step S24, the optimal K sets of first parameters Lₙᵢ is retained, and then proceeding to step S25. In S25, the optimal K sets of first parameters Lₙᵢ are mixed to generate new (S-K) sets of first parameters Lₙᵢ. After step S25 is completed, return to step S22 and repeat steps S21 to S25 for Y (i.e., the number of generations, which can be adjusted according to the actual case) generations. In step S25 of generation Y, the optimal wheeling contract parameters can be generated, including, for example, the first and second parameters belonging to a recommended solution. Then, proceed to step S3, outputting the optimal wheeling contract parameters. In addition, the calculation process for step S2 is illustrated below, but it is not limited to the description here.

In some embodiments, the genetic algorithm is used to make a wheeling decision of whether the electricity consumption site needs to purchase renewable energy based on the electricity consumption parameter, and the gradient descent algorithm is used to generate the proportion for allocating the green electricity from the plurality of electricity generation sites based on the wheeling decision and the renewable energy objectives, wherein the proportion for allocating the green electricity and the renewable energy objective are real-number parameters, and the electricity generation parameters and the electricity consumption parameters are integers.

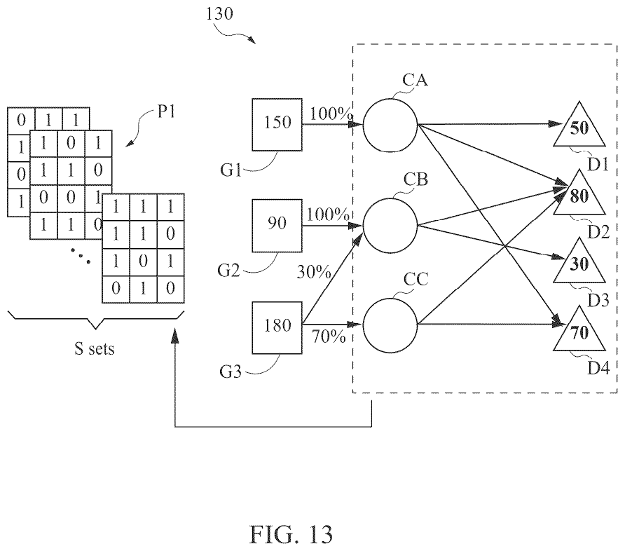

The first process corresponds to step S21, shown in FIG. 12. As shown in FIG. 13, a calculation process example 130 includes randomly generating S sets of first parameters Lₙᵢ (such as parameters P1 derived from a dotted box area in the right half of the figure). Specifically, S represents the number of sets to be generated. In the calculation process, S is equivalent to a population parameter in the genetic algorithm. In this example, each of the first parameters Lₙᵢ represents whether there is a wheeling relationship between the contract CA, CB, or CC and the electricity consumption site D1, D2, D3, or D4 (a relationship in a connection as shown in the figure). After the generating process is completed, S sets of binary matrices will be generated. For example, a value “0” indicates there is no connection (i.e., no wheeling relationship between the contract and the electricity consumption site), and a value “1” indicates that there is a connection (i.e., a wheeling relationship between the contract and the electricity consumption site). In the present example, the genetic algorithm can process the wheeling relationship represented by integers (such as 0 and 1).

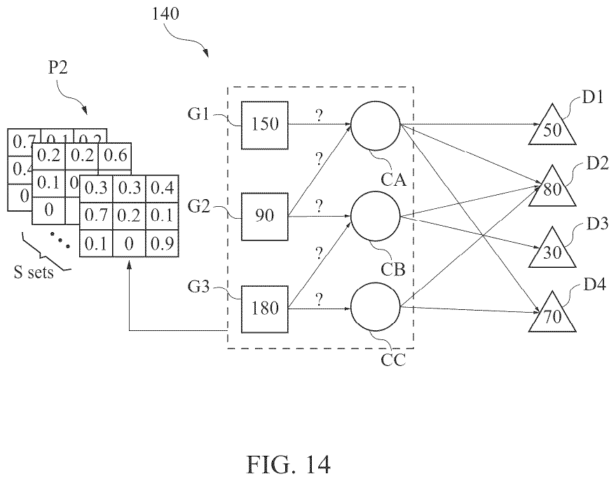

The second process corresponds to step S22, shown in FIG. 12. As shown in FIG. 14, a calculation process example 140 includes solving the second parameters Pₘᵢ (such as parameters P2 derived from a dotted box area in the left half of the figure) corresponding to the S sets of first parameters Lₙᵢ using the gradient descent algorithm. Specifically, each of the second parameters Pₘᵢ represents the proportion of electricity between the contract CA, CB, or CC and the electricity generation site G1, G2, or G3, being expressed as a value between 0 and 1 (e.g., real numbers such as a ratio or its corresponding value). In the present example, based on gradient descent, the first parameters Lni in the right half are fixed to find the optimized second parameters Pₘᵢ in the left half. In the present example, the gradient descent algorithm can handle the proportion of electricity expressed as a real number (such as a ratio between 0 and 1 or its corresponding value).

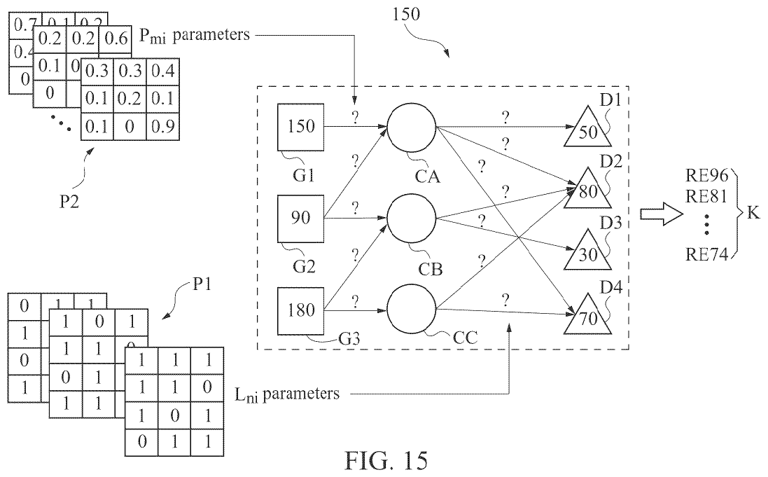

The third process corresponds to step S23, shown in FIG. 12. As shown in FIG. 15, a calculation process example 150 includes estimating the S sets of first parameters Lₙᵢ (representing an integer correlation matrix between the contract CA, CB, or CC and the electricity consumption site D1, D2, D3, or D4, e.g., the parameters P1 in FIG. 15, expressed in a matrix form) and the second parameters Pₘᵢ (representing a real-number correlation matrix between the contract CA, CB, or CC and the electricity generation site G1, G2, or G3, e.g., the parameter P2 in FIG. 15, expressed in a matrix form) to be brought into a wheeling computation process to select the top K sets of parameters (also called “approaching-objective parameters”) whose results are closest to the RE100 objective (e.g., RE96, RE81, . . . , RE74). For example, scores on the S sets of first and second parameters Lₙᵢ, Pₘᵢ are estimated using an objective function, and the scores are sorted from large to small. In addition, the optimal K sets of scores corresponding to the first and second parameters Lₙᵢ, Pₘᵢ are also selected.

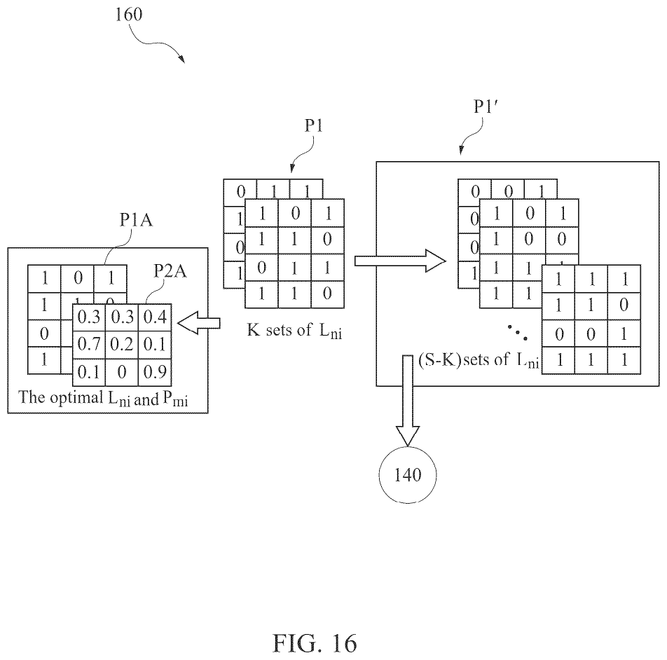

The fourth process corresponds to steps S24 and S25, shown in FIG. 12. As shown in FIG. 16, a calculation process example 160 includes, according to selected K sets of first parameters Lₙᵢ, e.g., retaining the optimal K sets of first parameters Lₙᵢ, which are mixed to generate new (S-K) sets of first parameters Lₙᵢ. Then, the next generation can be prepared to be performed. Step S22, corresponding to FIG. 12, is executed again, as the calculation process example 140 shown in FIG. 14. Specifically, suppose there is still the next generation to be carried out (i.e., the number of executed generations is less than Y). In that case, a crossover-and-mutation calculation process is performed based on the selected K sets of first parameters to generate new (S-K) sets of first parameters Lₙᵢ (e.g., the parameters P1′ shown in FIG. 16), then return to step S22 shown in FIG. 12 (that is, the calculation process example 140 shown in FIG. 14). In addition, suppose the current generation is the last one (i.e., the number of executed generations is equal to Y). In that case, the optimal first and second parameters Lₙᵢ, Pₘᵢ (parameters P1A and P2A shown in FIG. 16) are returned, which contain the wheeling relationship between different contracts and different electricity consumption sites and the proportion of electricity between different contracts and different electricity generation sites, they can be used as the basis for subsequent output of the optimal wheeling contract parameters.

It should be understood that the above example only illustrates examples in which the renewable energy objective is RE100, but it is not limited to the description here. During the optimization calculation process, each RE value can be analyzed, i.e., the objective can also be set as other values, such as RE99, RE98, and other RE values. For example, if the wheeling contract parameters for several RE values in which a difference between adjacent two RE values is one (such as RE90, RE91, RE92, . . . , and RE100) are established in sequence, it can be known the electricity consumption site's the green electricity consumption and the gray electricity consumption at different RE objectives, combined with the relevant green electricity rates and gray electricity rates, the green electricity expense and the gray electricity expense and other related electricity expenses can be calculated. Based on the above, a trendline derived from the total electricity purchase expense at different RE objectives at the electricity consumption site can be estimated.

For example, a bidirectional RE-cost trendline sweeping operation can also be performed to sequentially estimate the electricity expense corresponding to each RE objective during an optimization process, which helps to confirm whether the electricity purchase expense increases monotonically with the RE objective as a reference for renewable energy policies deployment.

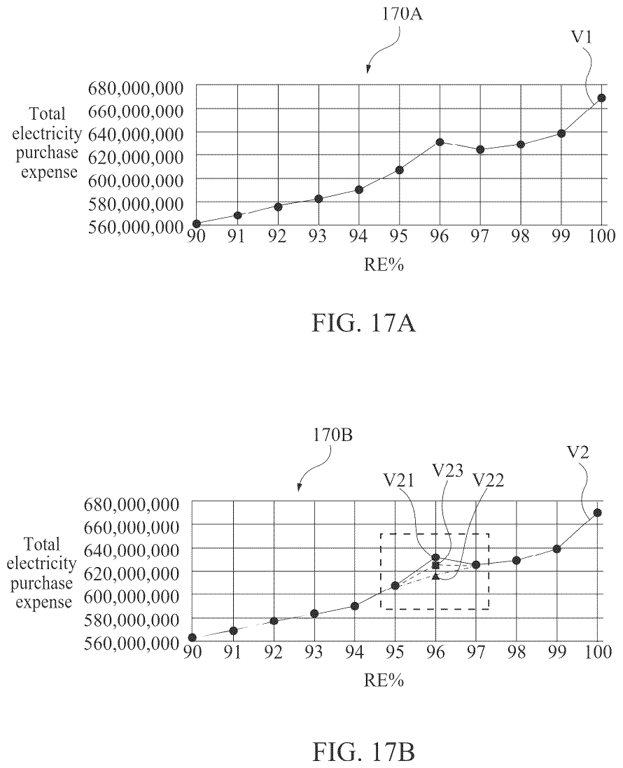

For example, as shown in FIG. 17A, an RE trend example 170A is shown, including a curve V1, in a forward sweeping manner, from left to right; each RE value from RE90 to RE100 is continuously optimized based on the previous wheeling results. For example, the total electricity purchase expense for each RE value can be used as an initial search value for the next RE value to speed up the search. For example, RE100 is continuously optimized based on the optimization result of RE99, RE99 is continuously optimized based on the optimization result of RE98, and so on.

In some embodiments, a cost-per-electricity-purchase curve includes several electricity purchase expenses corresponding to each renewable energy objective. The values of the renewable energy objectives increase in the forward direction and decrease in the reverse direction. The system can compare the electricity purchase expenses of adjacent two of the plurality of renewable energy objectives in the reverse direction. Suppose the electricity purchase expense of the larger one of the adjacent two of the plurality of renewable energy objectives is less than that of the smaller one of the adjacent two of the plurality of renewable energy objectives. In that case, the electricity purchase expense of the smaller one of the adjacent two of the plurality of renewable energy objectives is adjusted based on the electricity purchase expense of the larger one of the adjacent two of the plurality of renewable energy objectives.

As shown in FIG. 17B, an RE trend example 170B is shown, including a curve V2, in a reverse sweeping manner, from right to left, to confirm whether the trendline is monotonically increasing. In this example, the RE-cost trendline is not monotonically increasing. As shown in FIG. 17B, in a dotted box area, the total electricity purchase expense of RE96 is higher than the total electricity purchase expense of RE97, i.e., an initial result V21 of RE96 is worse than a result of RE97. Therefore, the result of RE97 can be used to optimize the result of RE96 to generate a fine-tuning result V22 of RE96. The fine-tuning result V22 of RE96 is expected to be better than the result of RE97. However, it should be noted that if the fine-tuning result V22 of RE96 is not as good as expected, for example, the electricity purchase expense of RE96 is higher than that of RE97, the result of RE96 can also be replaced based on the results of RE97 to generate a final adjustment result V23 of RE96 to facilitate the elimination of unreasonable electricity purchase costs for renewable energy. In the future, renewable energy cost optimization solutions can also be evaluated based on the RE-cost trendlines, such as purchasing renewable energy only, or purchasing renewable energy in combination with renewable-energy certificates to achieve a green-electricity-friendly usage environment.

In some embodiments, the system can generate a cost-per-electricity-purchase curve based on several electricity purchase expenses corresponding to several renewable energy objectives. The cost-per-electricity-purchase curve includes several costs per electricity purchase corresponding to each renewable energy objective. An electricity purchase guide is generated based on several costs per electricity purchase and a cost of purchasing renewable-energy certificates, wherein the electricity purchase guide indicates a recommendation to either purchase renewable energy from the at least one electricity consumption site, or purchase the renewable-energy certificates.

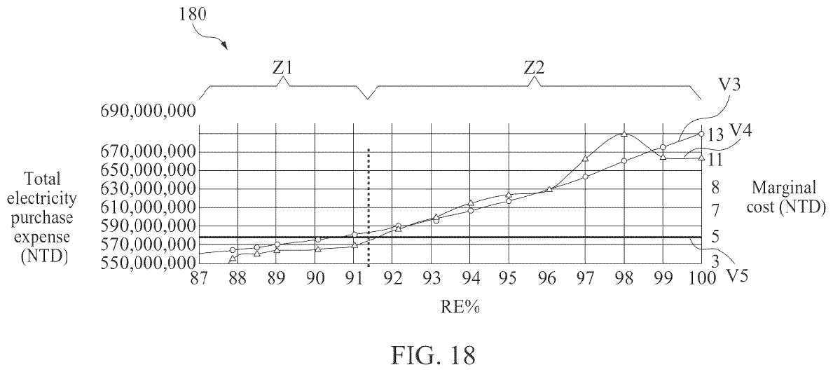

For example, FIG. 18 shows a renewable energy cost analysis example 180, in which a curve V3 is the RE-cost trendline from RE87 to RE100. A curve V4 is a marginal cost trendline with a stepwise fine-tuning range of RE1% from RE87 to RE100. For example, the marginal cost of increasing RE by 1% is a ratio of a variation in the total purchase cost of two adjacent RE values divided by a variation in gray electricity (such as the reduction of gray electricity or the addition of renewable energy usage) between the two adjacent RE values. A curve V5 is a cost trendline of renewable-energy certificates (such as Taiwan Renewable Energy Certificates, T-REC), assuming that the average price of T-REC is 5 NTD per kilowatt hour. It can be seen from FIG. 18 that an RE dividing line is drawn around the intersection of curve V4 and curve V5, which can be divided into areas Z1 and Z2. The area Z1 represents that the marginal cost of raising RE by 1% is lower than the renewable-energy certificate cost. Namely, to achieve the RE values within area Z1, purchasing more renewable energy to reduce gray electricity can be implemented. The area Z2 represents that the marginal cost of raising RE by 1% is higher than the renewable-energy certificate cost. Namely, to achieve the RE values within the area Z2, purchasing more renewable-energy certificates to reduce gray electricity can be implemented.

In some embodiments, the system can perform a determination of whether any one of the plurality of costs per electricity purchase greater than the cost of purchasing one of the renewable-energy certificates; the electricity purchase guide indicates the recommendation to purchase the renewable-energy certificates in response to the determination being positive, and the electricity purchase guide indicates the recommendation to purchase the renewable energy from the at least one electricity consumption site in response to the determination being negative. Therefore, if the RE value is used as the basis for the determination, in addition to directly purchasing green electricity to achieve renewable-energy planning objectives, purchasing renewable-energy certificates to achieve renewable-energy planning objectives scan/comparison further be used, allowing the electricity consumption site to achieve the diversity of renewable-energy planning objectives to meet the electricity consumption and cost needs of renewable energy.

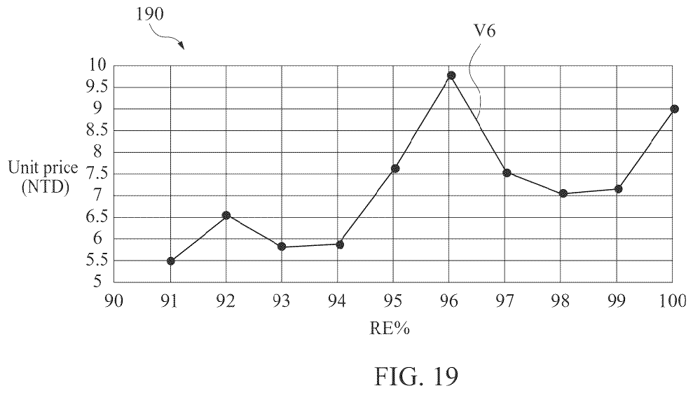

For example, based on the renewable energy cost analysis mentioned above, changes in the number of renewable-energy certificates and price purchase caps for different RE stages can also be planned. As shown in FIG. 19, an example 190 of unit price analysis for renewable energy is shown, in which curve V6 is a diagram illustrating the additional cost for green electricity per kilowatt hour for every rising 1% in RE starting from RE90. In this example, a reference point is set at RE90, i.e., if users want to upgrade from RE90 to RE96 by purchasing renewable-energy certificates, users need to purchase a total of 7,803 T-RECs (assuming 6% in RE corresponds to 7,802.257 kilowatt hours (kWh)). In addition, if the average electricity expense per kilowatt hour must be less than 9.77 NTD, it is more cost-effective to purchase renewable-energy certificates; if the average electricity expense per kilowatt hour is greater than 9.77 NTD, it is more cost-effective to purchase renewable energy directly. In this way, if the average electricity expense is used as the basis for the determination, then in addition to achieving renewable-energy planning objectives, it can also be determined whether the cost of purchasing green electricity or renewable-energy certificates is lower (more cost-effective) to meet the electricity consumption and cost requirements of renewable energy.

In another aspect, an embodiment of the present disclosure provides a renewable energy wheeling distribution method applied to a system including a processor and a memory, wherein the processor is coupled to the memory storing instructions which, when executed by the processor, cause the processor to execute the method including: providing a model for performing green electricity optimization on at least one electricity consumption site based on a genetic algorithm and a gradient descent algorithm, wherein the model generates at least one wheeling solution that satisfies a renewable energy objective according to a plurality of electricity generation parameters and at least one electricity consumption parameter, wherein the at least one wheeling solution includes matching relationships of green electricity between the at least one electricity consumption site and a plurality of electricity generation sites, as well as the proportion for allocating the green electricity within the matching relationships; repeatedly performing the green electricity optimization on a specific electricity consumption site based on a plurality of renewable energy objectives to generate a plurality of wheeling solutions; and calculating, based on the plurality of wheeling solutions and cost parameters, a renewable energy marginal cost as a ratio of a variation of electricity purchase expenses to an increment of green electricity corresponding to adjacent two of the renewable energy objectives. In the present disclosure, many implementation proposals of the method embodiments correspond to the system embodiments and will not be described again.

Renewable energy wheeling distribution systems and methods are provided in the present disclosure. For example, a model is provided to perform green electricity optimization on at least one electricity consumption site based on a genetic algorithm and a gradient descent algorithm to generate at least one wheeling solution based on a renewable energy objective according to a plurality of electricity generation parameters and at least one electricity consumption parameter, wherein the at least one wheeling solution includes matching relationships of green electricity between the at least one electricity consumption site and a plurality of electricity generation sites, as well as the proportion for allocating the green electricity within the matching relationships; the green electricity optimization is repeatedly performed on a specific electricity consumption site based on a plurality of renewable energy objectives to generate a plurality of wheeling solutions; a renewable energy marginal cost as a ratio of a variation of electricity purchase expense to an increment of green electricity corresponding to adjacent two of the renewable energy objectives is calculated based on the plurality of wheeling solutions and cost parameters; alternatively, an electricity purchase guide is generated according to a plurality of costs per electricity purchase corresponding to the plurality of renewable energy objectives, a plurality of costs per electricity purchases, and a cost of purchasing renewable-energy certificates. In this way, it is conducive to accurately achieving a wheeling objective, efficiently controlling costs, and considering alternative solutions for cost needs, such as purchasing energy certificates.

Although the present disclosure has been disclosed in the preferred embodiments, any person skilled in the art can make various changes and modifications without departing from the spirit and scope of the present disclosure. Therefore, the protection scope of the present disclosure shall be determined by the appended claims.

What is claimed is:

1. A renewable energy wheeling distribution system comprising a processor and a memory, wherein the processor is coupled to the memory storing instructions and configured to execute the instructions to perform processes comprising:
providing a model for performing green electricity optimization on at least one electricity consumption site based on a genetic algorithm and a gradient descent algorithm, wherein the model generates at least one wheeling solution that satisfies a renewable energy objective according to a plurality of electricity generation parameters and at least one electricity consumption parameter, wherein the at least one wheeling solution comprises matching relationships of green electricity between the at least one electricity consumption site and a plurality of electricity generation sites, as well as the proportion for allocating the green electricity within the matching relationships;
repeatedly performing the green electricity optimization on a specific electricity consumption site based on a plurality of renewable energy objectives to generate a plurality of wheeling solutions; and
calculating, based on the plurality of wheeling solutions and cost parameters, a renewable energy marginal cost as a ratio of a variation of electricity purchase expenses to an increment of green electricity corresponding to adjacent two of the renewable energy objectives.

2. The renewable energy wheeling distribution system as claimed in claim 1, wherein the processor is further configured to execute the instructions to perform the processes comprising:
generating a cost-per-electricity-purchase curve according to a plurality of electricity purchase expenses corresponding to the plurality of renewable energy objectives, wherein the cost-per-electricity-purchase curve comprises a plurality of costs per electricity purchase corresponding to each renewable energy objective;
generating an electricity purchase guide according to the plurality of costs per electricity purchase and a cost of purchasing renewable-energy certificates, wherein the electricity purchase guide indicates a recommendation to either purchase renewable energy from the at least one electricity consumption site, or purchase the renewable-energy certificates.

3. The renewable energy wheeling distribution system as claimed in claim 2, wherein the processor is further configured to execute the instructions to perform the processes comprising:
performing a determination of whether any one of the plurality of costs per electricity purchase greater than the cost of purchasing one of the renewable-energy certificates, wherein the electricity purchase guide indicates the recommendation to purchase the renewable-energy certificates in response to the determination being positive, and the electricity purchase guide indicates the recommendation to purchase the renewable energy from the at least one electricity consumption site in response to the determination being negative.

4. The renewable energy wheeling distribution system as claimed in claim 1, wherein a cost-per-electricity-purchase curve comprises a plurality of electricity purchase expenses corresponding to each renewable energy objective, and values of the renewable energy objectives are incremental in a forward direction and decremental in a reverse direction; and the processor is further configured to execute the instructions to perform the processes comprising:
comparing the electricity purchase expenses of adjacent two of the plurality of renewable energy objectives in the reverse direction; and
adjusting the electricity purchase expense of the smaller one of the values of the adjacent two of the plurality of renewable energy objectives based on the electricity purchase expense of the larger one of the values of the adjacent two of the plurality of renewable energy objectives if the electricity purchase expense of the larger one of the values of the adjacent two of the plurality of renewable energy objectives is less than the electricity purchase expense of the smaller one of the values of the adjacent two of the plurality of renewable energy objectives.

5. The renewable energy wheeling distribution system as claimed in claim 1, wherein the processor is further configured to execute the instructions to perform the processes comprising:
performing the green electricity optimization on the plurality of electricity consumption sites based on a specific renewable energy objective in response to a request; and
generating a display interface based on the matching relationships of green electricity between the plurality of electricity consumption sites and the plurality of electricity generation sites within the wheeling solution, wherein the display interface comprises a plurality of first visual characteristics corresponding to the plurality of electricity generation sites, a plurality of second visual characteristics corresponding to the plurality of electricity consumption sites, and a plurality of intermediate visual characteristics corresponding to the matching relationships and located between the plurality of first visual characteristics and the plurality of second visual characteristics, and wherein the display interface further comprises flows, in which each of the plurality of first visual characteristics is connected to at least one of the plurality of second visual characteristics through at least one of the plurality of intermediate visual characteristics.

6. The renewable energy wheeling distribution system as claimed in claim 5, wherein the display interface further comprises a surplus-electricity visual characteristic located between the plurality of first visual characteristics and the plurality of second visual characteristics, and the display interface further comprises one or more flows in which at least one of the plurality of first visual characteristics is connected to the surplus-electricity visual characteristic.

7. The renewable energy wheeling distribution system as claimed in claim 5, wherein the processor is further configured to execute the instructions to perform the processes comprising:
forming data for a waterfall chart according to the flows, setting the data for the waterfall chart corresponding to one or more flows of each of the plurality of first visual characteristics to be associated with a color, and setting the data for the waterfall chart corresponding to one or more flows of each of the plurality of second visual characteristics to be associated with a color, wherein the color associated with each of the plurality of first visual characteristics and the color associated with each of the plurality of second visual characteristics are different.

8. The renewable energy wheeling distribution system as claimed in claim 5, wherein the processor is further configured to execute the instructions to perform the processes comprising:
setting the plurality of first visual characteristics, the plurality of second visual characteristics, and the plurality of intermediate visual characteristics to be associated with a plurality of colors.

9. The renewable energy wheeling distribution system as claimed in claim 1, wherein the processor is further configured to execute the instructions to perform the processes comprising:
making a wheeling decision of whether the electricity consumption site needs to purchase renewable energy based on the electricity consumption parameter using the genetic algorithm;
generating the proportion for allocating the green electricity from the plurality of electricity generation sites based on the wheeling decision and the renewable energy objectives using the gradient descent algorithm, wherein the proportion for allocating the green electricity and the renewable energy objectives are real-number parameters, and the electricity generation parameters and the electricity consumption parameter are integers.

10. The renewable energy wheeling distribution system as claimed in claim 1, wherein the processor is further configured to execute the instructions to perform the processes comprising:
performing a first operation for executing the genetic algorithm to randomly generate a first plurality of sets of first parameters based on the electricity consumption parameter, wherein the first plurality of sets of first parameters indicates one or more wheeling relationships between the at least one electricity consumption site and a plurality of intermediary sites;
performing a second operation for executing the gradient descent algorithm to solve a second plurality of sets of second parameters that are optimized, based on the first plurality of sets of first parameters, wherein the second plurality of sets of second parameters indicates electricity ratios between the intermediary sites and the electricity generation sites;
performing a third operation for estimating an integer correlation matrix for the first plurality of sets of first parameters and a real-number correlation matrix for the second plurality of sets of second parameters, selecting a third plurality of sets of first parameters and second parameters closest to the renewable energy objective from the integer correlation matrix and the real-number correlation matrix according to an objective function;
performing a fourth operation for generating a fourth plurality of sets of first parameters based on mixing the third plurality of sets of first parameters closest to the renewable energy objective, wherein the fourth plurality is a difference obtained by subtracting the third plurality from the first plurality; and
re-executing each of the second operation, the third operation, and the fourth operation once as an iteration based on the fourth plurality of sets of first parameters until repeatedly executing a fifth plurality of iterations to generate optimal first and second parameters to serve as one of the at least one wheeling solution.

11. A renewable energy wheeling distribution method applied to a system comprising a processor and a memory, wherein the processor is coupled to the memory storing instructions which, when executed by the processor, cause the processor to execute the method comprising:
providing a model for performing green electricity optimization on at least one electricity consumption site based on a genetic algorithm and a gradient descent algorithm, wherein the model generates at least one wheeling solution that satisfies a renewable energy objective according to a plurality of electricity generation parameters and at least one electricity consumption parameter, wherein the at least one wheeling solution comprises matching relationships of green electricity between the at least one electricity consumption site and a plurality of electricity generation sites, as well as the proportion for allocating the green electricity within the matching relationships;
repeatedly performing the green electricity optimization on a specific electricity consumption site based on a plurality of renewable energy objectives to generate a plurality of wheeling solutions; and calculating, based on the plurality of wheeling solutions and cost parameters, a renewable energy marginal cost as a ratio of a variation of electricity purchase expenses to an increment of green electricity corresponding to adjacent two of the renewable energy objectives.

12. The renewable energy wheeling distribution method as claimed in claim 11, further comprising: generating a cost-per-electricity-purchase curve according to a plurality of electricity purchase expenses corresponding to the plurality of renewable energy objectives, wherein the cost-per-electricity-purchase curve comprises a plurality of costs per electricity purchase corresponding to each renewable energy objective; generating an electricity purchase guide according to the plurality of costs per electricity purchase and a cost of purchasing renewable-energy certificates, wherein the electricity purchase guide indicates a recommendation to either purchase renewable energy from the at least one electricity consumption site, or purchase the renewable-energy certificates.

13. The renewable energy wheeling distribution method as claimed in claim 12, wherein the generating the electricity purchase guide according to the plurality of costs per electricity purchase and the cost of purchasing renewable-energy certificates comprises: performing a determination of whether any one of the plurality of costs per electricity purchase greater than the cost of purchasing one of the renewable-energy certificates, wherein the electricity purchase guide indicates the recommendation to purchase the renewable-energy certificates in response to the determination being positive, and the electricity purchase guide indicates the recommendation to purchase the renewable energy from the at least one electricity consumption site in response to the determination being negative.

14. The renewable energy wheeling distribution method as claimed in claim 11, wherein a cost-per-electricity-purchase curve comprises a plurality of electricity purchase expenses corresponding to the plurality of renewable energy objectives, and values of the plurality of renewable energy objectives are incremental in a forward direction and decremental in a reverse direction; and the method further comprises: comparing the electricity purchase expenses of adjacent two of the plurality of renewable energy objectives in the reverse direction, and adjusting the electricity purchase expense of the smaller one of the values of the adjacent two of the plurality of renewable energy objectives based on the electricity purchase expense of the larger one of the values of the adjacent two of the plurality of renewable energy objectives if the electricity purchase expense of the larger one of the values of the adjacent two of the plurality of renewable energy objectives is less than the electricity purchase expense of the smaller one of the values of the adjacent two of the plurality of renewable energy objectives.

15. The renewable energy wheeling distribution method as claimed in claim 11, further comprising: performing the green electricity optimization on the plurality of electricity consumption sites based on a specific renewable energy objective in response to a request; and generating a display interface based on the matching relationships of green electricity between the plurality of electricity consumption sites and the plurality of electricity generation sites within the wheeling solution, wherein the display interface comprises a plurality of first visual characteristics corresponding to the plurality of electricity generation sites, a plurality of second visual characteristics corresponding to the plurality of electricity consumption sites, and a plurality of intermediate visual characteristics corresponding to the matching relationships and located between the plurality of first visual characteristics and the plurality of second visual characteristics, and wherein the display interface further comprises flows, in which each of the plurality of first visual characteristics is connected to at least one of the plurality of second visual characteristics through at least one of the plurality of intermediate visual characteristics.

16. The renewable energy wheeling distribution method as claimed in claim 15, wherein the display interface further comprises a surplus-electricity visual characteristic located between the plurality of first visual characteristics and the plurality of second visual characteristics, and the display interface further comprises one or more flows in which at least one of the plurality of first visual characteristics is connected to the surplus-electricity visual characteristic.

17. The renewable energy wheeling distribution method as claimed in claim 15, further comprising: forming data for a waterfall chart according to the flows, setting the data for the waterfall chart corresponding to one or more flows of each of the plurality of first visual characteristics to be associated with a color, and setting the data for the waterfall chart corresponding to one or more flows of each of the plurality of second visual characteristics to be associated with a color, wherein the color associated with each of the plurality of first visual characteristics and the color associated with each of the plurality of second visual characteristics are different.

18. The renewable energy wheeling distribution method as claimed in claim 15, further comprising: setting the plurality of first visual characteristics, the plurality of second visual characteristics, and the plurality of intermediate visual characteristics to be associated with a plurality of colors.

19. The renewable energy wheeling distribution method as claimed in claim 11, further comprising: making a wheeling decision of whether the electricity consumption site needs to purchase renewable energy based on the electricity consumption parameter using the genetic algorithm, and generating the proportion for allocating the green electricity from the plurality of electricity generation sites based on the wheeling decision and the renewable energy objectives using the gradient descent algorithm, wherein the proportion for allocating the green electricity and the renewable energy objectives are real-number parameters, and the electricity generation parameters and the electricity consumption parameter are integers.

20. A renewable energy wheeling distribution system comprising a processor and a memory, wherein the processor is coupled to the memory storing instructions and configured to execute the instructions to perform processes comprising:
generating at least one wheeling solution based on a renewable energy objective according to a plurality of electricity generation parameters and at least one electricity consumption parameter, wherein the at least one wheeling solution comprises matching relationships of green electricity between the at least one electricity consumption site and a plurality of electricity generation sites, as well as the proportion for allocating the green electricity within the matching relationships; and
repeatedly performing green electricity optimization on a specific electricity consumption site based on a plurality of renewable energy objectives to generate a plurality of wheeling solutions, to generate a plurality of costs per electricity purchase corresponding to each renewable energy objective according to a plurality of electricity purchase expenses corresponding to the plurality of renewable energy objectives, and to generate an electricity purchase guide according to the plurality of costs per electricity purchase and a cost of purchasing renewable-energy certificates, wherein the electricity purchase guide indicates a recommendation to either purchase renewable energy from the at least one electricity consumption site, or purchase the renewable-energy certificates.
